(19) United States
(12) Patent Application Publication
(10) Pub. No.: US 2022/0044589 A1
(43) Pub. Date: Feb. 10, 2022

(54) Systems and methods for helping language learners learn more

(71) Applicant: Christopher Persaud, Winnetka, CA (US)

(72) Inventor: Christopher Persaud, Winnetka, CA (US)

(21) Appl. No.: 17/355,155

(22) Filed: Jun. 22, 2021

Related U.S. Application Data
(60) Provisional application No. 63/042,097, filed on Jun. 22, 2020.

(51) Int. Cl. G09B 19/06; G06F 40/58; G09B 5/02

(52) U.S. Cl. CPC G09B 19/06; G06Q 50/2053; G09B 5/02; G06F 40/58

(57) ABSTRACT

The invention includes a group of programs that help people learn languages. The programs include explanations of the grammatical rules of the language that a user is trying to learn, and statistical analyses of the types of errors that the individual user makes, and ways that these errors can be corrected. Most embodiments reinforce students' language learning using systems of visual displays, data graphics, and a “grammar of graphics”. The programs can be run on cellular phones, computers, and other electronic devices. The programs can be used by a student to learn a language, or by an instructor to augment a class being taught to students. Some embodiments also allow a student to preserve records of his or her progress and the types of errors that he or makes, between classes, allowing an instructor to tailor a class to the strengths and weaknesses of the students in the class.

### DESCRIPTION OF THE RELATED ART

A “foreign” language for purposes of this patent application means a language that is not a student's native language. For example, for purposes of this patent application, English would be a “foreign” language to a person whose native language is Spanish. Likewise, Spanish would be a “foreign” language to a person whose native language is English. A “student” for purposes of this patent application means a person learning a language. An “instructor” is a person teaching a language, for purposes of this patent application.

A “facilitator” is a person leading an informal group studying a language (For example, New York University (NYU) and Harvard University appear to sponsor informal groups of students who spend an hour conversing in a language to improve their practice in that language). A “curator” is a person who examines the submissions of individuals regarding a specific language, and “curates” the submissions to make sure that they are correct before they are offered to the general public. Curators are primarily relevant regarding languages that are spoken by very few people, or to help monitor change in a language, such as new words being added to the language. The same person can be an “instructor” and a “student”, or a “curator” or a “facilitator”, or fulfill three or four of these roles, regarding different languages, or at different times (For example, the person might be a student in a language for several years, earn an M.A. or Ph.D. in that language, and then become an instructor in that language).

A “cohort”, for purposes of this application, is a group of students with at least one common characteristic. A cohort can be a group of students in one class, in one institution, in a certain geographic area, or the students who enrolled in a class in a certain time period, or a group of students that have another characteristic in common, or who have a defined combination of defined characteristics in common.

An “institution”, for purposes of this application, is a school, college, or another entity where classes are offered. High schools and universities are two examples of types of institutions.

A “class”, for purposes of this application, is a course of study over a defined period of time, which can be undertaken by a student, and a desired outcome concerning what the student should learn from the course of study, and with the student's success in learning the material covered by the desired outcome in the course of study being measured in some way, either directly or by some proxy measurement.

For purposes of this application, an “in-person” class is a class where, to attend a class, a student must physically visit a location where the class's instructor is teaching. A “remote” class is where the instructor's words are broadcast to the student, by radio, telephone, the internet, or another method, and so the student can attend the class without being in the same location as the instructor.

Individuals have needed to learn foreign languages for travel, commerce, and other reasons for thousands of years. Now, as international business is becoming more common, the need for individuals to learn foreign languages has increased. Language learning is also important to this country because many of its citizens need to be aware of, and understand, cultures and countries besides the U.S.

Today, U.S. citizens need to learn new languages to engage in commerce with many other nations, and may need to learn these languages quickly, and without the ability to attend an institution to learn them. U.S. citizens may also need to learn dialects, or regional languages, which may not be available through regular institutions.

Citizens of other countries also need to learn foreign languages, for the same reasons as citizens of the U.S. It must be noted that the education systems of many other countries place much more emphasis on learning languages than the education system in the U.S. For example, many citizens of India can speak multiple languages, and language learning is emphasized more in the education systems of many European countries than it is in the U.S. When the inventor herein was walking down a well-kept street in Shanghai, China, a beggar asked him for money in perfect English, suggesting that the Chinese educational system is highly proficient at teaching English. The inventor is also personally aware of a large Chinese company that hires American teachers to teach English, one-on-one, to Chinese children using videochat services. This large Chinese company facilitates English teaching for millions of children in China.

The inventor also notes that greater proficiency in language-teaching, in general, may help a country to capture foreign markets more easily. For example, if the Chinese education system is proficient in teaching English, this may translate into a proficiency in teaching Portuguese, which might then help Chines companies to capture Brazilian markets that might presently be served by U.S. companies.

Learning a language through enrolling in, and completing, in-person classes has historically been one of the most common ways of learning languages, and is an effective way of learning languages under ideal conditions, but conditions are rarely ideal, and this approach, when implemented in practice, suffers from several deficiencies. These problems include:

### Economic Problems

An in-person class almost always involves a fixed schedule and fixed set of assignments and exams, and some students cannot undertake this schedule because of other factors in their lives. For example, a student may not be able to attend the class, or may lack reliable transportation to that class, or the student may have to work, and not have the time to devote to completing all the assignments for the class, in the time allotted, but may be able to complete some of them.

A student may also desire to progress in his or her understanding of a language, but not to progress at the specific schedule of the in-person class.

Language classes at community colleges have high dropout rates. When a student “drops out” of a community college language class, this usually represents wasted energy for the student (who does not receive academic credit) and wasted money for a state or federal government (that subsidized the class).

The problem of students dropping out of a language class is also present at other colleges and universities, though generally less so. At all universities where classes are subsidized in some way by a state or federal government, if a student drops out of a language class, this usually represents wasted energy for the student (who does not receive academic credit) and wasted money for a state or federal government (that subsidized the class).

Furthermore, many university students in the U.S. receive student loans. If a student who receives student loans drops out of a language class, this probably represents wasted money for the state or federal government (which subsidized the student).

If a student lives in poverty, this will also affect the student's ability to learn a new language. A small but significant percentage of Los Angeles County Community College students, for example, live in poverty, are homeless, or suffer from food insecurity. The Los Angeles Community College District serves tens of thousands of students at any one time, so a “small but significant percentage” of students can be thousands of individual students.

Jill Biden, First Lady of the United States, wrote her Ed.D. thesis on “Student Retention at the Community College”, which shows the vital concern many professors, administrators, and state officials have for student retention in community colleges, and the need to help community college students to complete their language learning through keeping the language learning in digestible modules. First Lady Biden also noted that there are many social, economic, and other obstacles that community college students may face, in completing classes (including language classes) because of other factors in the students' lives.

These factors show a need for a flexible alternative to in-person language classes, that allows students to learn at their own pace, or to augment in-person language classes.

Recently, there has been increased concern in the U.S. that members of certain ethnic groups, such as African-Americans, are disadvantaged in the educational system, because of past and/or present social problems. The present invention can help to ameliorate these disadvantages by providing more information about the learning styles of individual students (including African-American students) so that classes can be to some extent tailored to the learning styles of the individual students in a class.

There is also historic (and present) concern about gender equality in education, in the U.S. and other countries. The present invention can help to ameliorate these disadvantages can also help to ameliorate these disadvantages by providing more information about the learning styles of individual students (including both male and female students) so that classes can be to some extent tailored to the learning styles of the individual students in a class. Differences in learning styles based on gender should be reflected in differences in individual learning styles.

The invention will also help high school students who wish to practice for Advanced Placement (AP) exams to practice and study for them. This is especially important for students from poorer socioeconomic backgrounds, who may not have access to teachers and AP classes, but who may want to take AP exams. It is known that schools in poorer areas tend to have access to fewer AP classes than schools in wealthy areas.

The invention will also help students to able to study (and hopefully gain proficiency in) languages that might not be available for study in those high schools. This is also very true of high schools in poorer areas, and smaller high schools. For example, Hebrew and Latin are among the languages available for study at Stuyvesant, one of the best high schools in New York City. They are available for study at very few high schools, however. The invention will help these two languages, and others, to be available for study at more high schools and other academic institutions.

Problems Connected to Language Teaching Styles

One problem with present language teaching is that students have different language learning styles, and instructors have different teaching styles and philosophies. The language teaching style that an instructor chooses to use in an in-person class may not be the most effective style for helping all students in that class to learn the language. The instructor may also have an accent that impedes comprehension for some students.

There are also numerous theories, among language teachers, concerning the “right”, or “most effective”, way to teach a new language to students. Some of these theories have empirical support, but are most effective within specific contexts. For example, they might be most effective with students who study 10 hours per week, but be disproportionately less effective with students who study less. This means that some language teaching methods may be more effective at certain educational institutions, rather than others. For example, a language teaching method which is most effective with students who study a language for 10 hour per week will tend to be more effective when executed at an educational institution where most of the students have at least 10 hours per week available to devote to language study. An instructor must take such idiosyncrasies into account, when determining the right language teaching method to use. If an instructor is relying on empirical studies to determine whether a language teaching method is effective, the instructor must examine the context in which the studies took place, to determine whether the studies' conclusions are applicable to an institution where the instructor teaches.

Other theories concerning language teaching have no empirical support.

Some of these theories are also more effective with some languages than others, because of the different characteristics of different languages (For example, some theories might be more effective for English speakers learning French vs. English speakers learning Arabic, because French uses the same alphabet as English, while Arabic does not).

The reality is that not all students learn languages the same way. One objective of the invention is to help a student determine their most effective language-learning style and focus on it.

The present invention is designed to accommodate different language teaching styles and philosophies among language teachers. The present invention was also designed with the goal of being adaptable to any new language teaching styles and philosophies that are likely to emerge.

Logistical Problems of the Institutions

Schools and colleges in the United States are often faced with problems such as budget cuts, which mean that they might be forced to stop offering language classes, and related services, that they had offered previously. An educational institution may not have enough of a budget (or may never have had enough of a budget) to offer all the language classes, or all the support systems related to languages learning that, it desires to offer.

Additionally, institutions may be subjected to state or federal directives, that have good intentions but are counterproductive or perverse in practice, or administrators at the institutions may try to implement these directives in ways that are counterproductive.

Furthermore, educational institutions, by necessity, must often focus the in-person classes they offer on the most “popular” languages, which tend to be languages with the largest number of speakers. If an institution wishes to offer a class in a less popular language, the demand for that class, among students, might be insufficient for the institution to justify offering that class. Few educational institutions in the United States will offer in-person classes in more than twenty languages.

Very few institutions will be able to offer classes in some languages that are relatively uncommon, but have millions of speakers. For example, in the United States, few educational institutions can offer classes in Dutch and Thai, though these languages have millions of speakers.

The coronavirus crisis, which began in 2020, has created a new wave of problems related to language learning, and education in general. Many universities, school districts, and other institutions were forced to shift all of their classes to an “online” format, which caused numerous problems with student achievement and retention.

The coronavirus crisis appears to be diminishing in the United States, as of the filing date of this patent application. However, other countries, such as India, continue to experience crises related to the coronavirus, and it is also possible that in the future there will be other national or regional crises related to the coronavirus, or crises related to some new disease. Institutions should be more resilient, to deal with the possibility of such crises. It is possible that institutions in specific geographic areas, in the U.S. and elsewhere, will be periodically forced to switch their classes to a completely remote temporarily to deal with regional disease outbreaks, and then switch back to partially or fully in-person schedules when these outbreaks are over.

In fact, schools in many areas of the U.S. were forced to cancel classes temporarily for weeks at a time during polio outbreaks, before polio vaccines were introduced in the 1950's. For example, schools in City A may have been forced to close for a few weeks during a polio outbreak, while schools in City B continued operating because there was no outbreak in City B. Then schools in City A would resume because the outbreak in City A had ended, while at the same time schools in City B would be forced to close for weeks while an outbreak happened there. Then, two or three years later, polio outbreaks might happen in City A and B again, forcing schools to close in both cities for weeks again.

The present invention will help educational institutions to become more resilient, at least in the field of language teaching and to deal with crises that might temporarily force them to close, while protecting student outcomes.

Many people learn languages at community colleges, and community colleges, because of their flexible schedules and relatively low cost, provide much of the language teaching in America.

Some schools and colleges also offer online classes, but these suffer from some of the same deficiencies as in-person classes, though often to a reduced degree. Some online classes also suffer from other issues—Some colleges and universities have created online classes with a very large number of students per class (1000 or more) which results in less individual attention per student, and higher dropout rates.

“Massive Online Open Courses” (MOOCs) are online courses open to large numbers of students, where the online students can listen to lectures, and have access to other course materials. They may have access to the same course materials as students simultaneously taking an in-person course. Some MOOCs allow students to participate in blog posts, or email the instructor and/or students. However, students often get insufficient language practice, in MOOCs devoted to languages.

MOOCs in general also have low completion rates. According to some studies, MOOCs have completion rates of at most 15%.

The present invention can complement or replace MOOCs in languages. If it is used to complement an MOOC in a language, the present invention can lead to an increase in the number of students completing the MOOC.

These factors show the need for a method of language learning that can function while students are forced to experience rapid shifts in priorities, or are enrolled in a class which is forced to switch from an in-person format to a remote format, and can also offer the students individualized feedback.

### INVENTIONS OF THE PRIOR ART AND THEIR DIFFERENCES FROM THE PRESENT INVENTION

The following prior art was found, which was believed to be relevant, and which should be mentioned in an information disclosure statement:

U.S. Pat. No. 7,104,798 by Spaventa is a method of teaching students a language utilizing a coded medium through verbal and nonverbal communication. The students unconsciously learn the structure of the language through color, sound, shape/texture, a verb puzzle piece, gestures and grammar stories. The method includes the presentation of a new linguistic structure to the students to elicit linguistic responses from the students. The students are encouraged to respond verbally. A student is then directed to display the linguistic structure using the coded medium. The student response is then reviewed and corrected to ensure that all students use the correct gesture referencing time when addressing the puzzle piece. The teacher moves the coded medium corresponding to the correct punctuation to teach word order, syntax, cohesion and other linguistic features. A second student is directed to respond to the first student verbally and by displaying the linguistic structure with the coded medium. The students are directed to write the linguistic structure and draw pictures of the coded medium corresponding to the linguistic structure. These activities are repeated until quick and skillful responses are delivered automatically. Grammar stories are role played and reinforce the language program. The grammar stories, manipulation of the coded medium and the verb puzzle pieces and suffix word used in the method put language in a time and space relationship. Thus students unconsciously learn the structure of the language through the coded medium, gestures and grammar stories.

U.S. Pat. No. 7,052,278 by Johnson, et. al. provides a system and method for language teaching that involves training to an automatic level a set of core vocabulary items, and then presenting learned items in combination as a means of implicitly teaching grammar. In one aspect, a method for teaching a language, consistent with the invention, comprises: (a) while displaying to a learner a graphical representation of a vocabulary item comprising at least one word, playing to the learner an audio recording comprising the spoken form of the vocabulary item; and (b) while displaying to a learner both a graphical representation of the vocabulary item and the written form of the vocabulary item, playing to the learner an audio recording comprising the spoken form of the vocabulary item.

U.S. Pat. No. 6,866,510 by Polanyi et. al. describes a technique for teaching second language writing skills, which provides for analyzing a user text. The user text is analyzed and compared to a writing culture. The differences between the user text and the writing culture are identified. The identified differences are compared to linguistic flaw information previously compiled from other second language texts written by first language writers in the writing culture. Identified differences that are found in the linguistic flaw information store are used to retrieve contextually relevant corrections and comments for addressing the identified flaws based on the first and second language and writing culture.

U.S. Pat. No. 6,438,515 by Crawford, et. al. describes a method and apparatus for displaying dual texts in a manner to facilitate language learning, by presenting a highly visible “study text,” divided into individual units of thought, or “chunks of meaning,” which are preferably formatted in association with less visible units of a “teach text,” provided in proximity, preferably upon a separate focal plane, thus effecting a bitextual, bifocal presentation. The method and apparatus clearly relate the study text and the teach text, associating their individually related chunks of meaning, storing these associations in computer memory, as “.txt” or “Unicode equivalent” files, which, when organized into folders, allow computer programs to access these associations and automatically produce bitextual, preferably bifocal, presentations. These presentations can preferably be accessed in publications printed on paper, such as in books and magazines, and can also be accessed by users over a computer network, such as the Internet, and displayed.

Kristen Sosulski's book “Data Visualization made simple” describes various data visualization methods, and ways that some of these methods can be used to enhance a viewer's comprehension of the material. Kristen Sosulski does not attempt to apply these methods specifically to language teaching, though.

“Canvas” is a system for offering courses on the internet through an institution. Canvas allows instructors to create a group of “modules”, each of which can contain tests and explanations of material. Each instructor must create the modules themselves, however. An example would be a an instructor of Spanish creating a module based on the “subjunctive”, which is a grammatical mood in Spanish and other languages. No two instructors will necessarily create identical modules, which makes effective comparison of student performance more difficult.

There are also no standards regarding what kind of content is required for Canvas modules, which means that many instructors include features in their modules that do not help students' performance, or that actively hinder students' performance, or the performance of certain subgroups of students.

Canvas also includes a display of “course analytics” but the course analytics have the limitation that they only include information about one section of one course, and the analytics are based on the assignments and exams created by a specific instructor, for that specific course.

There is no attempt to compare performance and other information across sections, or across courses, or institutions, and indeed such a comparison would probably be impractical, because the comparison would involve comparing different groups of students' performance on different assessments that assessed different material, or comparing groups of students who are not part of the same cohort.

### Long-Felt but Unsolved Need

The present invention can be used to learn a language by a user who is not enrolled in any class, but for best results, the user should enroll in a class in the language that the user desires to learn, at the same time as the user is using the invention to try to learn that language.

There is a long-felt but unsolved need for a computerized system that helps people to learn languages but which accommodates differences in learning styles, social changes, offers flexibility in schedules, and which can be used easily in conjunction with in-person classes.

There is also a long-felt but unsolved need for a means of recovering or reducing the money that is spent on subsidized classes when students drop out, especially when they drop out for reasons that are unrelated to a class—For example, when students have to drop out for family reasons.

One of the principles behind this invention is that individuals can learn visually. The present invention tries to engage the user different kinds of thinking, on the theory that this will help the user to retain information better.

Recently, the coronavirus pandemic has forced many instructors to build or expand websites or microsites for courses that they teach. However, there is often no quality control for this, and many of the microsites or websites are ineffective or have limited effectiveness.

### SUMMARY OF THE INVENTION

This invention was partly inspired by conversations over many years with Loknath Persaud and Arabella Persaud. Loknath Persaud teaches at Pasadena City College, in Pasadena, Calif., and Arabella Persaud taught for many years at Los Angeles Southwest College, and recently retired. Christopher Persaud, the inventor herein, was also influenced by his experiences as a student at Cal State L.A., University of Miami, Ave Maria Law School, and New York University's Stern School of Business.

The present invention is also useful for addressing and accommodating changes within an institution's schedule of classes. For example, if an institution is forced to move a class to a time which is inconvenient for some students, or to cut the number of times it offers a specific course in a term, the present invention will help the institution to alleviate the negative effects that may stem from this.

The present invention is also not intended to replace language instruction at colleges, or language professors.

### SOME OF THE PRINCIPLES BEHIND THE INVENTION

Some of the principles behind the invention are that 1. Preattentive attributes can be utilized to help students learn. 2. If the same lesson is given to a student in multiple formats, the student is more likely to appreciate at least one of the formats. 3. Our eyes are drawn to patterns we already know, and patterns that we already know can be utilized this to improve retention. 4. Instructors, and educational administrators, can give better advice to students and groups of students if they know how much the students are studying, how the students are studying, and what areas in which the students might be having trouble. 5. Visualizations work best when they display information in patterns that are both familiar and easy to spot. Stephen Fry, 2009. 6. Students learn better when they connect knowledge to information that they already have. 7. Data graphics can sometimes be used to communicate information more easily to people who don't speak a language. 8. Some scholars have argued that the rate at which information is lost after being learned is basically a function of how the information is learned. Anderson, 2000, p. 174, as cited by Sosulski. Putting information in practice immediately after it is learned is important.

### TERM NUMBERS

The following term numbers shall apply to different components of the invention. (1) Individual interface. (2) Display device. (3) Grammar engine. (4) Grammar network map. (5) Individual tracking module. (6) Individual Complete Record. (7) Exporting module. (8) Interpersonal matching module. (9) Word record. (10) Charting module. (11) Words database. (12) Grammar Rules Database. (13) Word-tense database. (14) Sentence generator. (15) Identifier. (16)(17)(18) Cohort statistical engine. (19) Cohort achievement display. (20)

Each student can be assigned an identifier (15) which will be kept as a permanent record of the student's completion of all of the class modules, related to all of the languages, that the student has completed.

The identifier can be a username, a user number, a social security number, or something else, for example, the identifier can be any of the other types of identifications for individual records that are present in the art. The identifier will identify the individual complete record (6) of the student. The individual complete record will be a record of the efforts that the student has made to learn languages through the invention. At a minimum, the individual complete record will include a record of all the modules, in every language, that the user has ever attempted to complete.

The individual complete record will also include records of the amount of time that the student has spent on each of the modules, and records of the number of mistakes that a student has made, and statistical information about the types of mistakes that the student has made. For example, the individual complete record can include information about the percentage correct the student scored, in each of the class modules the student has completed. The individual complete record can also include information about whether the student examined “explanatory” material more than once, in any class module, and how many times the student examined it.

The student can (And should, but need not be required to) fill out demographic information in the Individual Complete Record. This will enable analysis of the student's performance and actions later, which will be important to instructors and educational administrators trying to tailor lessons to the student's level of proficiency, or assess the characteristics of groups of which the student is a part.

The demographic information which the student can fill out will include, but not be limited to, the student's age, location, name, gender, ethnicity, and any institution(s) which the student has attended or is attending, and any course(s) at those institutions that the student has enrolled in, is presently enrolling in, or has completed, especially courses in the languages that the student is trying to learn. The student can also fill out information about his or her goals for using the invention. This was, more “casual” learners can be distinguished from students who have a more immediate need for the invention, such as those who are using the invention to get practice for classes they are enrolled in right now.

The student should also fill out the student's native language(s), and any other languages that the students know, as part of the student's demographic information. This is very important, because the invention will often display things like instructions in one of the student's native languages.

The student's Individual Complete Record is important, because, among other reasons, the student will be able to develop a record of his or her completion of modules in each language over time. Instructors will also be able to examine the students' past completion of class modules, to determine how much the student has already learned about a language, and to tailor a class to the level of exposure that the students in that class have previously had in the language. The instructor can also get a better understanding of the types of errors that students in the class tend to make, and tailor the class appropriately.

The identifier should be protected by the student, through password protection, two-factor authentication, and/or any of the other methods known in the prior art. Many versions of the invention will utilize such protection for the identifier.

### SOME VERSIONS OF THE FIRST EMBODIMENT

The first embodiment of how the invention will work is below. It relies on presenting information, and presenting language-related problems, for the student to solve. The student will view the information and view and solve the problems using a display device (2) which can be a personal computer, a smartphone, or another type of computing device.

Many languages, such as Romance languages, have highly structured grammar, with different “tenses” for words, and other specific forms of words, to use in certain situations. The invention helps students to learn grammar rules. Students deserve to know how a language they are learning is structured, and also to expand their vocabularies, while doing so, if possible.

One of the principles behind this group of embodiments of the invention is that people tend to remember information that is connected to unique or memorable situations, and another is that people tend to remember information that is immediately useful. For example, the inventor's mother, Arabella Persaud, used Fluffy, their cat, to illustrate the names, in Spanish, of body parts such as eyes and ears. This helped the inventor to remember the Spanish terms for these body parts. Students might be able to learn better if they see visuals that are there to help them learn, so the first embodiment will provide students with multiple types of visuals to help them learn about the language(s) they are studying. The invention also includes close statistical monitoring of students' performance, so that each student will be given more of the types of lessons that work for that student.

The first embodiment of the invention, when being used to help a student learn a specific language, can include a large number of “class modules”, each of which is essentially a subpart of a class relating to that specific language. Many of the “class modules” will each focus on a specific, defined, topic. For example, the first embodiment should have a class module devoted to each of the Spanish verb tenses.

Please note that the total number of class modules relating to each language should be enough that the material covered by all the class modules for that language, all added together, would comprise enough material for more than one class in that language. The study of each language, using the invention, should be broken into a large number of individually small class modules related to each language because actual classes in many languages will cover varying topics, that vary depending on the institution or even on the individual instructor. For example, a class entitled “German 1” at Institution A may cover topics 1, 2, 3, 4, and 5, and “German 2” at Institution A may cover topics 6, 7, 8, 9, and 10, while a class entitled “German 1” at Institution B may cover topics 1, 2, 3, 4, and 6, and “German 2” at Institution B may cover topics 5, 7, 8, 9, and 10. The students and instructors at each institution will need to pick the class modules, using the invention, that most apply to their needs. The chances of the students in each class finding a combination of class modules, that fits their specific needs, is therefore higher if there are more class modules that each cover a smaller area.

For purposes of this application, a “word type” is a kind of word, such as a noun, verb, etc.

The first embodiment of the invention can be utilized when a grammatical rule is being explained to a student, through the individual interface, and an example of the grammar rule being used is being presented through the individual interface. The example may be included in a sentence. The different parts of the sentence, which are examples of different grammar rules being used, can be shown in different colors.

For example, if one of the words in the sentence is a verb in the future tense, then that word is an example of the future tense being used. If “blue” indicates the future tense, then the verb in the future tense will be colored blue when displayed.

Then, in later example sentences and paragraphs that are presented to the student, including those sentences and paragraphs that illustrate different grammar rules, the parts of a sentence that illustrate each rule are shown in the same color as that rule. For example, if “blue” indicates the future tense in the lesson on the future tense, and later on, the student is being given a lesson on the past tense, and the color “green” indicates the past tense, then if a verb with the future tense is also in one of the example sentences about the past tense, the verb in the future tense will be shown in blue, while the verb in the past tense will be shown in green.

Each of the grammar rules being utilized is shown on the screen, in the same color as the part of the sentence that illustrates that rule. The grammar rules may be explained in other ways, too, for example, a rule may be spoken, using the display device's audio capability, while it is being shown onscreen.

Each part of the sentence that uses a particular grammar rule may be highlighted (while being displayed in the color appropriate to a sentence part expressing that particular grammar rule) and the grammar rule displayed on the screen, in addition to the sentence. Or, the parts of the sentence can be highlighted in succession, again while each part is displayed in the color appropriate to a sentence part expressing the particular grammar rule utilized by that sentence part. While each part of the sentence is highlighted, the grammar rule utilized by that sentence part is also shown on the screen of the display device (2).

Pictures may also be used to illustrate the rule. For example, a video or cartoon of an animal doing something, where the words that describe the animal's actions in the language the student is studying use the grammar rule on which the class module is focused. This can also be shown at the same time as the grammar rule, or without the grammar rule.

The different colors and illustrations help the user to remember the different grammar rules.

In the first embodiment, the same color should always illustrate the same grammar rule being used, in the same language, and in each of the class modules relating to that language, for the same student. Otherwise, students will be confused. For example, if the color “green” represents a specific verb tense in Spanish, green should represent that verb tense throughout the class modules related to all verb tenses, and all other class modules, related to Spanish, in exercises where color is used to distinguish between applications of grammatical rules.

Different colors can illustrate the same grammar rule being used in the same or different class modules relating to the same language for different students, but that is not preferable because it will reduce the students' ability to cooperate and potentially confuse students.

The combined use of data graphics with words will help people students to learn the language and help the audience (students) to see what is most important (The language's structure and vocabulary).

Humans' visual systems have their own rules. Humans do not attend to everything they see. This is important in deciding what will be displayed to a student when the student is being taught a grammar rule.

The first embodiment of the invention will involve a words database in which are stored words for the language the student wishes to learn. It will also involve a grammar rules database, in which are stored grammar rules for that language. There will also be a sentence generator. There will also be an individual complete record.

The words database (11) for the language will include a very large number of words for the language. The more words are included in the words database, as a general rule, the better. If there are 100,000 or more words in a language, then having 100,000 or more words in a words database will be helpful. The type of word (preposition, noun, verb, adverb, etc.) for each word should also be included as a datum for that word in the words database. Please note that some languages have word-types that English does not have. A words database for a language other than English, that has word-types that are not present in English, would include word-types that are present in that language, but not in English, in the words database. The words database might also include “difficulty levels” for the words, where a difficulty level for a word will be assigned numerical level for the difficulty for that word. In general, longer words would be assigned higher difficulty levels.

The word database should also include translations for the words, into English and as many other languages as possible. Each word entered into the word database would have a translation into English for the word, and translations into other languages.

The word database can also have assigned color for each word type. For example, nouns would have one assigned color, pronouns another color, etc.

The words database can also be updated as time goes on; For example, a words database for a language may start with 10,000 words, and then more words may be added later, so that the words database later has 50,000 words, then 100,000, etc. This may be necessary for some languages.

Second, the first embodiment of the invention will include a grammar rules module (12) which will include grammar rules for the same language as the words database. The grammar rules will each express how a word needs to be modified to be grammatically correct in a certain context. For example, the grammar rules module for Spanish will include rules that modify a Spanish verb for each Spanish verb tense.

The sentence generator, in the first embodiment creates sentences out of words in the words database.

For example, the sentence generator can have multiple formats of sentences. Each sentence will each have a format that will be specified as a sequence of types of words, with one or more specific types of word appropriate for each place in the sentence. For clarity, within this application, each word in one of the generated words will be referred to as having a numbered place in the sentence. The first word in the sentence will have place 1, and the second will have place 2, etc. Hereafter, in this application, when a sentence is explained, the different types of words in that sentence will be placed in parentheses. One example of a sentence in English would be represented as (Definite article) (noun)(verb)(adverb). This is a representation of a sentence where the first word, in place 1, is a definite article, the second word, in place 2, is a noun, the third word, in place 3, is a verb, and the fourth word, in place 4, is an adverb.

The sentence formats will have varying word lengths, which are compatible with the language the student is trying to learn, and rules of the language. Other sentence formats could be longer or shorter, or the same length, as the example given above. Another example of a sentence format in English accessible by the sentence generator, with a different format, would be represented in this application as (noun)(adjective)(verb)(indefinite pronoun)(definite article)(noun-plural). Here, the word at place 6 has the additional attribute of being “plural”. Within this application, each additional attribute for each of the words in a sentence selected by the sentence generator will be indicated by a hyphen.

A sentence in another language, would be composed of the word types applicable to that language. For example, a sentence in Spanish might have all nouns with the attributes of masculine or feminine.

The sentence generator will only generate sentences that conform to the grammar rules grammatical rules relating to the language the student is trying to learn.

The sentence generator might, for example, be equipped with a large number of sentence structures, where each sentence structure would specify which type of word goes in each place in the sentence. For example, the sentence generator can have one hundred and fifty sentence structures in English, or more, or less. The sentence generator can pick between these sentence structures. It can pick randomly or according to another method. For example, the sentence generator can be designed to pick less difficult sentences in the beginning, and more difficult sentences later.

The determination of which word type would go with which place in the sentence would be programmed into the sentence generator for each sentence structure in the first embodiment. For example, the sentence structure (noun)(adjective)(verb)(indefinite pronoun)(definite article)(noun-plural) would have a noun at place 1, a plural noun at place 2, etc.

Note that sentence structures in English can differ from sentence structures in other languages. The sentence structures for each language should be consistent with the rules of that language.

In some versions of the first embodiment of the invention, once a sentence structure is picked by the sentence generator, the sentence structure is sent by the sentence generator to the Grammar Rules Module. The Grammar Rules Module will select a word for each place in the sentence from the Words Database, and the word selected for each place in the sentence will be a word of the type indicated for that place in the sentence by the sentence generator. As described above, each word in the Words Database will have a datum indicating what type of word it is. So, for example, if place 1 in the sentence is supposed to contain a noun, the Grammar Rules Module will select a noun for place 1 in the sentence. If place 2 in the sentence is supposed to contain a noun, the Grammar Rules Module will select a noun for place 2 in the sentence. The grammar rules module also makes sure that the words in the sentence are all expressed grammatically correctly. For example, if the word at place 3 in a sentence is supposed to be a verb in the future tense, then the Grammar Rules Module will convert the verb from the Words Database at place 3 into the future tense of that verb, using the grammar rules programmed into the Grammar Rules Module. If the word at place 5 is supposed to be a verb in the present participle, then the Grammar Rules Module will convert the verb from the Words Database at place 5 into the present participle of that verb.

In some versions of the first embodiment, the grammar rules module will also include additional color commands to change the color of each word, when displayed, if the word has certain specific attributes. For example, if a verb has a specific tense, the verb might have a specific shade of green when displayed.

In some versions of the first embodiment, the grammar rules module will also include additional information to display next to, or with reference to, each word if the word has certain specific attributes. For example, if a verb has a specific tense, the verb might be italicized when displayed.

The Grammar Rules module will then display the sentence on the display device of the student. In most embodiments, the text of one or more of the grammatical rules applying to the sentence will also be displayed on the display device.

Preattentive attributes may also be displayed on the display device. because humans learn better when they can fit knowledge into familiar patterns. Preattentive processing is a fast process of recognition. It is not cognitive, and the viewer is not thinking about what the viewer is seeing.

### The Problem Generator

The first embodiment will also have a problem generator. The problem generator operates differently from the sentence generator.

The problem generator will generate a series of problems such as “apply rule X to the following words”, and will take words from the words database to which the student should apply rule X. The problem generator will then display the problems, and the student will try to complete them. The problem generator will also send these same words from words database to the grammar module, which will apply rule X to the words and create answers, then send the answers to the problem generator. The problem generator will then compare the student's answers to the “correct” answers generated by the words database, and store information about the student's success at inputting the right answers.

The problem generator may also take a sentence, generated by the sentence generator, with a missing part. The student will have to enter the missing part. The problem generator will then compare the student's answer to the correct answer generated by the problem generator to see if the student has gotten the right answer, and store information about whether the student got it.

The problem generator can also present the student with problems that force the student to think in a different way, which will help strengthen the student's understanding of the material.

An example is: The student, an English speaker who is learning Spanish, is presented with a sentence in Spanish. The sentence is missing a word. The student has been given a series of colors that correspond to different tenses of the word. The student will then have to decide which of the colors corresponds to the color of the missing word. In other words, the student will have to determine the tense of the missing word, because tense corresponds to color in the example.

In some embodiments, the student will be presented with “demonstration” exercises, to complete, in a language that the student is learning. The student may also be presented with examples of sentences that have been correctly completed. In the example sentences, each verb tense will have its own color. When the student needs to write a response, each tense for the words used in the response will be programmed with its own color. Therefore, the student will be able to quickly see which tense the answer is in, and to modify the answer, to get the tense desired by the student. The student will learn visually, by seeing the colors, along with paying attention to the words on the screen, and the combination will be more effective than if the student were learning the words alone.

For example, for “estar”, a word in Spanish, the words “estoy”, the first-person tense, and “estas”, the familiar second-person tense, will have different colors.

By visually learning the colors, the student will have a better idea of the structure of a language.

This will also be effective for students trying to “keep up” their knowledge of a language when they are taking a “break” from formally studying the language.

The present invention will also utilize analytics to determine where a student has the most “trouble” learning a language, by charting the types of errors the student makes most often. For example, in romance languages, the invention may chart what types of questions the student gets wrong most often, or the types of grammatical errors the student makes most while writing compositions. A version of the invention will then seek to help the student correct these errors, by informing the student of the types of errors he or she is making most often, and giving the student more exercises that test the principles the student is violating by making the errors. For example, if the student is studying Spanish and makes the largest number of mistakes in using “ser” when he or she should be using “estar”, or vice versa, then the invention will explain the 15 difference between the two words, and give the student more exercises where he or she is supposed to choose between “ser” and “estar”.

The first embodiment will also attempt to help students see the relationships between words in other ways. One way is through, in class modules, showing a language as a type of network diagram, with words as the “nodes” and the relationships between the words as “edges”.

Another example of using a node-and-edge system to help the student, which will also be part of the first embodiment, would be as follows: The student would be asked to form a sentence, with a specific structure. The student would be presented with a series of words to start the sentence. The student would pick one, and it would be shown as a node. Then the student would be given a group of other words for position 2. Some of these could follow the first word but not in a way that would complete the sentence using the desired structure. Others could follow the first word in a way that would complete the sentence using the desired structure. The student will pick one of these words, and it would be shown as another node. An edge will be between the two nodes. Then other words will be presented to the student that could be at position 3 while still being grammatically correct. The student will pick one of these, and will keep picking words in the same manner until the student reaches the number of words in the sentence. However, this exercise will not be marked correct unless the structure of the sentence the student has created matches the desired sentence structure. The student will have to change the order of words, and pick other words, if the student's sentence has the wrong structure.

In the second embodiment, the invention will also have the following capability: A language, such as Spanish, will be charted in terms of relationships between words. An example is the word “ser” in Spanish. In one embodiment, the invention will include a large database of words in Spanish. Words that can precede “ser”, in a grammatically correct Spanish sentence, will have edges going to “ser”, and words that “ser” can precede will have edges going from “ser” to those words. The network will be displayed for the user to see, when the user is introduced to a new word. The user will also be able to trace the “edges”, to see how many words are connected to “ser”. If the edges that link to “ser” are highlighted, and shown against the entire network, then this will show the user that a large amount of the network connects to “ser”. This will help the user to understand how some words are more “central” to a language than others, in that some words are used more than others. For example, in English, a large portion of the words are prepositions. They are “central” to the English language, in that they are used more than other words.

If a student learning English is shown a visual representation of the relationships of other words in the database to “is”, for example, then this will help to impress upon the student that the word “is” can be used in a lot of ways, and help the student to remember the word “is” and how to use it. The word being inspected would be “is”, in this case.

In some embodiments of the invention, the user will be able to trace the words on the “other end” of the edges connected to the word being inspected. The user will be able to “click” on one of those edges, and each of the words connected to that edge will be displayed. The user will therefore be able to expand his or her vocabulary and command of the language that he or she is learning, by learning which words “go with” another, specific word, in a sentence. In some embodiments of the invention, the user may be presented with a network view of the words in the database, and the words that have been shown in lessons the student has experienced so far will be highlighted, along with the edges leading from those words. This will help the student to understand where the words he or she has encountered “fit in” to the overall language. This will help the user to learn more words, and how to use them, in the future, Multimedia learning theory: The way people construct knowledge from words and pictures.

Visualizations work best when they display information as patterns that are both familiar and easy to spot.

Memory plays an important role in human cognition, but working memory is limited.

When highlight is easier to see information, therefore we can highlight all the word parts of a certain type.

Analysis of structure: seeing what words are placed together. Then making network graphs about these words, and using them to decide what words to show an individual, to practice, to get maximum benefit.

### Use of Voice

In another embodiment of the invention, a voice speaks the paragraph, and the parts of each word are highlighted as the voice speaks them.

In another embodiment, the user speaks, and the computer renders what the answer sounds like, so it can be compared to the real answer.

Color does not need to be the distinguishing feature between parts of a sentence that illustrate use of different grammatical rules. The parts of a sentence that illustrate use of different grammatical rules could also be distinguished on the basis of font, size, or in any other way that 1. Can allow for easy visual distinguishing of application of different grammar rules and 2. Is consistent between class modules relating to the same language, that rely on easy visual distinguishing of application of different grammar rules.

### Use of the Statistical Results of the Efforts of Students

Analysis of structure: seeing what words are placed together. Then making network graphs about these words, and using them to decide what words to show an individual, to practice, to get maximum benefit.

The programs within the invention can be divided into class modules, by which each class module includes a specific point. For example, in Spanish, there can be a class module for the past tense, and a class module for the future tense. This way, an instructor can track which class modules the instructor's students have completed, and determine the progress of the students. An instructor can also determine the progress of students who have previously taken another class in the same language, before becoming students of that instructor. The instructor can look at the class modules that a student has completed so far, and then decide, based on this, whether the student is qualified for the first course in a sequence, the second course, etc. A dashboard is a type of graphical user interface which often provides at-a-glance views of key performance indicators (KPIs) relevant to a particular objective or business process. Dashboards can be used by individual students to measure their progress, and by instructors and administrators to measure progress of groups. The students' results can be shown on a dashboard.

The group achievement display will display statistical information about the amount of time that a cohort of students spent on each module of the program. Averages and standard deviations of the amount of time that a cohort The information can be available Then, if an

Some potential uses of this information are if an instructor, for example, notices that the amount of time that is being spent on one of the modules is 5.5 hours, and

Data can be broken down by institution.

A virtue of this system is that it is dynamic; If the characteristics of the students at an institution change within one semester, for example, the group achievement display will show this.

Students can also figure out whether they are spending enough time on a module. For example, if a student knows that in his cohort, people spend an average of 6 hours on a certain module, and he has spent 4 hours on that module, he should consider spending more time on this.

Social changes of all kinds can affect the ability of students to study. For example,

One advantage of the present invention is that it creates a single, centralized resource for monitoring the amount of effort that students have made, and the results of that effort.

Summary statistics, that go to instructor, about how the amount students study, and what they did, changes.

Chart about types of words that person learns and types of sentences they do.

Get data from students to improve system at first, and make initial recommendations, and then continue to get more data.

Teachers maybe can use it individually to find out whether groups of students are having trouble with a specific thing and trying to find that thing.

Ability to export stuff on csvs and excel files.

Idea: People add words for a language and a curator organizes it.

Push notifications in Spanish

ESL learning

One standard progress methods so can compare college to high school.

Note how long since last use of the platform to discuss review.

This can also help students from areas without AP classes to practice for APs.

Possibility of showing videos of animals when the user answers some questions correctly-similar to how the inventor's mother, Arabella Persaud, used Fluffy, their cat, to illustrate the names of body parts such as eyes and ears.

Difference between interaction and animation: Interaction data output is changed depending on what user wants.

### Use for Educational Administration

The invention will also include a centralized listing which will describe the amount of effort that students with certain characteristics put forth, to master specific modules of the program.

The characteristics will include, for example, students in a certain geographic area, or students at a specific school. An instructor will be able to view this information and find out the mount of effort required to achieve certain milestones, and advise students accordingly. For example, an instructor might advise students that reaching a certain milestone within a month has taken students in that instructor's class ten hours, spent on the program. An individual student who has spent 8 hours using the program during that month will therefore be able to conclude that he or she needs to spend more time on the program, and perhaps needs to rearrange his or her schedule to do it.

The listing will be useful for an instructor to quickly recognize changes in the characteristics of the student body that the instructor is teaching, and to quantify such changes more easily. For example, if the average length of time that the students in an instructor's class take to reach a certain milestone is 20% higher this semester than it was last semester, the instructor will notice this quickly, and be able to take measures to help the students, instead of gradually learning about changes in the student body anecdotally.

The instructor will also be able to quantify the difference in effectiveness between that instructor teaching in person and teaching remotely, which is important during the COVID-19 crisis.

In some embodiments, the instructor may be able to correlate student's grades to some measure such as length of time spent on the program, using linear regression or another statistical technique. The instructor can then make this information known to students so they can make better decisions about the amount of time they should spend studying.

The instructor can do this by entering the performance level that is required for each grade into the program. The program keeps track of the amount of effort required to reach each performance level, for students in the city, school, etc. The program can therefore create an average of the amount of effort required to reach each performance level, for students in a city. This is a greater number of data points than an instructor will have access to. The program can then use the different levels of amount of effort, for each performance level to create a graph of effort vs. performance level, and the slope of this graph should be the rate of increase of performance for each increment of effort.

“Effort” can also be defined in multiple ways, and the performance level, as a function of effort, can be shown for each of these ways. For example, “Effort” can be defined as hours spent using the program, number of page views, number of page views over a certain size, or in other ways.

The invention can also be used to show why or why not a change in a university's classes should happen, by examining the change in students' performance when similar changes were made at other universities. For example, if University 1 reduces the number of class sessions in a Chinese class, per week, from 3 to 2, and then the average amount of effort that students from University 1 take to reach a milestone, which is part of the required objectives for that Chinese class, increases, then this is an indication that University 2 should not reduce the number of class sessions in an equivalent class from 3 to 2 per week.

### Density Plot of Learners.

It can also provide data for the administration about what the right moves re: cutting classes are.

Analysis of structure: seeing what words are placed together. Then making network graphs about these words, and using them to decide what words to show an individual, to practice, to get maximum benefit.

The invention can be used as a guidepost to standardize MOOCs.

Use as Continuing Research Tool about how People Learn Languages.

The invention can be used to analyze language structure and changes in language structure.

### Use for Tutoring and Use by Facilitators

Facilitators can use it to figure out where people in the group are.

The inventor recommends against any instructor basing a student's grade upon a student's performance in class modules that weren't specifically assigned by that instructor. That is because a student may have previously tried to learn a language on his or her own, before enrolling in the instructor's course, and may simply not have been paying attention when the student attempted some of the previous class modules. Therefore the student's performance on these class modules might not have indicated the student's true level of ability or commitment when taking a class from the instructor. If students are graded by an instructor based on their performance in class modules that weren't specifically assigned by that instructor, this will also discourage “casual” language learners, which is undesirable and counterproductive. Casual learners should not be discouraged, and one of the reasons for the creation of this invention is to help people who are casual learners to learn languages.

Words and the Links Between them Based on Statistics

### Adding Words to a Database on a Language

A feature of the invention will allow users to “add” words to the central database of a language, as follows. A user can suggest a word for inclusion in the central database related to a language, and suggest a definition for that word. The central database will keep track of the number of times that this word is suggested. Then, when the number of suggestions reaches a certain number, a curator will examine whether the word should be added to the database for that language, and, if appropriate, will add that word to the database, and give that word a definition. The word will also be placed as a node within the network diagram, relating to that language.

Useful for rare languages, to make sure they don't die.

### ADDITIONAL EMBODIMENTS

The embodiments of the invention can also be used to monitor changes in the effectiveness of different learning techniques within a student body.

### THE SECOND EMBODIMENT

### An Embodiment of the Invention in Action

The discussion included in this patent is intended to serve as a basic description. The reader should be aware that the specific discussion may not explicitly describe all embodiments possible, and alternatives are implicit, or obvious to those skilled in the art. Also, this discussion may not fully explain the generic nature of the invention and may not explicitly show how each feature or element can actually represent equivalent elements. Again, these are implicitly included in this disclosure. Where the invention is described in device-oriented terminology, each element of the device implicitly performs a function. It should also be understood that a variety of changes may be made to the embodiments that have been described, without departing from the essence of the invention. Such changes are implicitly included in the description. These changes still fall within the scope of this invention.

Idea of using stochastic optimization and simulation to determine how a person is likely to do on a test, by using the person's scores on certain types of questions, and randomization of the types of results they might experience, and weighting of the types of questions, to determine the scores that the person is likely to get. Also randomizing the weights of the types of questions.

### BRIEF DESCRIPTION OF THE DRAWINGS

FIG. 1 describes a version of the first embodiment of the invention in action. The sentence generator picks a sentence to generate, and then

### DETAILED DESCRIPTION OF THE DRAWINGS

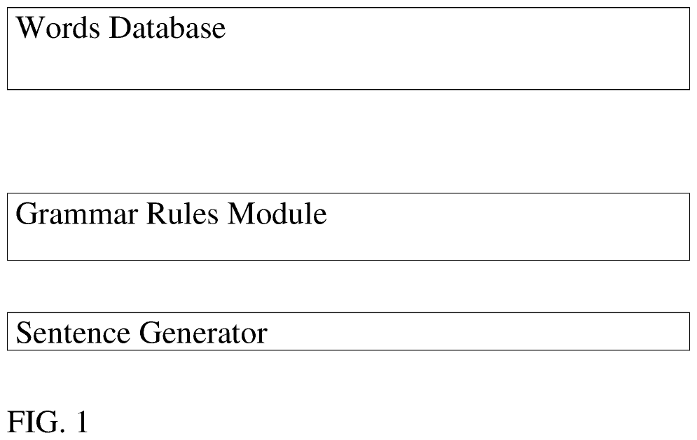

FIG. 1 describes a version of the first embodiment of the invention in action.

1. A method of teaching students by giving them a series of sentences created by the sentence generator with different parts in color.
